(19) United States
(12) Patent Application Publication
(10) Pub. No.: US 2018/0305627 A1
(43) Pub. Date: Oct. 25, 2018

(54) INDUSTRIAL FURNACE INTEGRATED WITH BIOMASS GASIFICATION SYSTEM

(71) Applicant: L'Air Liquide, Societe Anonyme pour l'Etude et l'Exploitation des Procedes Georges Claude, Paris (FR)

(72) Inventors: Remi TSIAVA, Saint Germain-les-Corbeil (FR); Biao HUANG, Shanghai (CN); Shenqi XU, Shanghai (CN); Bo WEI, Shanghai (CN)

(73) Assignee: L'Air Liquide, Societe Anonyme pour l'Etude et l'Exploitation des Procedes Georges Claude, Paris (FR)

(21) Appl. No.: 15/762,708

(22) PCT Filed: Sep. 21, 2016
(86) PCT No.: PCT/CN2016/099567

§ 371 Date: Mar. 23, 2018

(30) Foreign Application Priority Data
Sep. 24, 2015 (CN) PCT/CN2015/090534

(51) Int. Cl. C10J 3/66; C10J 3/24; F27B 9/36

(52) U.S. Cl. CPC C10J 3/66; C10J 3/24; F27B 9/36; F27M 2001/01; C10J 2300/1606; F27M 2001/07; C10J 2300/0916

(57) ABSTRACT

An integrated apparatus of industrial furnace and biomass gasification system and a process of operating said system are disclosed. Hot flue gas containing high concentration of CO₂ and water issued from an industrial furnace such as a glass furnace or a melting furnace for non-ferrous metals is introduced into a biomass gasification system as a heat source to promote the pyrolysis of biomass and/or as a gasification agent to generate syngas. The generated syngas is blended with solid-fuel such as petcoke before being introduced into the industrial furnace to facilitate ignition and combustion of petcoke. Overall CO₂, NOₓ and SOₓ emission from the industrial furnace are reduced, and the lifetime of the industrial furnace is increased.

### CROSS-REFERENCE TO RELATED APPLICATIONS

This application is a § 371 of International PCT Application PCT/CN2016/099567, filed Sep. 21, 2016, which claims § 119(a) foreign priority to International PCT Application PCT/CN2015/090534, filed Sep. 24, 2015.

### BACKGROUND

### Field of the Invention

This disclosure relates to an integrated apparatus comprising an industrial furnace and a biomass gasification system and a process of operating said apparatus.

### Related Art

Biomass is a renewable energy source from living or recently living organisms and it includes plant-based materials and animal waste.

Depletion of fossil fuels, emission of carbon dioxide that might cause global warming and generation of air pollutes, such as NOₓ and SOₓ are some of the urgent environmental challenges that need to be tackled.

Biomass, including vegetation, human and animal waste, is a renewable and sustainable source of energy. Biomass energy has significant environmental benefits, including a small net emission of CO₂ and other air pollutes, compared with fossil fuels. A promising application for biomass is the production of syngas through gasification process. Syngas may serve as fuels and feedstock chemicals for combustion process. However, the properties of low energy density, seasonal characteristics, difficulty to collect, transport, and maintain the supply restrict the industrial-scale biomass utilization.

Petroleum coke (petcoke) is a challenging fuel due to its low volatile content, high sulfur and nitrogen content, which give rise to undesirable emission characteristics. However, the low price and increased production of petcoke from high-sulfur feedstock give a powerful economic stimulus to use it for supplying heat. It has been widely applied in commercial furnaces, especially in China, such as glass furnaces.

U.S. Pat. No. 8,100,991B2 discloses a biomass gasification apparatus including an externally heated rotary kiln thermal cracking unit that indirectly heats and thermally cracks a biomass material to generate a tar containing pyrolysis gas and char from the biomass material, and a gasification unit that receives the tar-containing pyrolysis gas and char from the thermal cracking unit, and thermally cracks the tar component in the pyrolysis gas and gasifies the char by oxidation gas introduced therein. Hot syngas from gasifier was employed to heat the biomass material.

U.S. Pat. No. 8,100,992B2 describes a biomass thermo-chemical gasification apparatus which can produce high temperature fuel gas without using any other fossil fuel as heat source. A primary gasification reaction room is located inside this gasification apparatus, and combustion gas generated in a high temperature combustion apparatus is introduced into the gasification apparatus and heat the outer wall of the primary gasification reaction room. Consequently, the biomass is converted to clean and high quality fuel gas which could be used as fuel gas for methanol synthesis.

U.S. Pat. No. 8,528,490B1 reveals a biomass gasification system for efficiently extracting heat energy from biomass material. The biomass gasification system includes a primary combustion chamber, a rotating grate within the primary combustion chamber for supporting the biomass during gasification.

U.S. Pat. No. 7,185,595B2 discloses a combustion process of petroleum coke using air to carry the fuel into a combustion zone and to provide a source of oxidant. Enhanced combustion utilizes oxygen introduced into or proximate primary, secondary, tertiary, quaternary, or over-fire air to effect primary combustion of the fuel. Petroleum coke fuel in an oxygen supported air-petroleum coke combustion process can be used to re-power a utility boiler.

GB 2,143,939B describes a method of burning petroleum coke dust in a burner flame having an intensive internal recirculation zone. The petroleum coke dust is supplied to that region of the intensive recirculation zone, which provides the ignition energy for the petcoke dust which is to be burned.

### SUMMARY OF THE INVENTION

An objective of the invention is to achieve energy saving in the biomass gasification system and reduce the consumption of fossil fuel. Combustion process in the furnaces produces flue gas containing high concentrations of CO₂ and H₂O with very high temperature. The high temperature flue gas could be utilized in the biomass gasification system as heat source to improve pyrolysis and gasification of biomass. The furnace use fossil fuels such as petroleum coke (petcoke) as fuel, and the consumption of fossil fuels could be reduced by blending syngas (containing CO and H₂) generated through gasification of biomass with petcoke to ensure ready ignition as well as stable and complete combustion of petcoke in the furnace. This way, the volume of petcoke needed for a certain combustion process may be decreased, which leads to reduced SO_{X} concentration in the furnace, thereby elongating the life time of the furnace.

Another objective of the invention is to reduce CO₂ emission from industrial furnaces burning solid-fuels like petcoke. Examples of such furnaces include glass furnaces and melting furnace for non-ferrous metals, which produce flue gas containing high concentrations of CO₂ and H₂O with very high temperature. Part of the flue gas is introduced into a biomass gasification system as one of the pyrolysis agent to provide heat source or gasification agent or both, thereby reducing emission of CO₂ to the environment.

In one aspect, this invention discloses an integrated apparatus comprises a biomass gasification system containing a pyrolysis unit and a gasifier unit, an industrial furnace, a conduit feeding a stream of flue gas containing CO₂ and H₂O issued from the industrial furnace into the biomass gasification system and a conduit feeding a stream of syngas generated in the biomass gasification system into the industrial furnace, wherein the stream of flue gas is introduced into either one or both of the pyrolysis unit and the gasifier unit of the biomass gasification system.

In another aspect, this invention discloses an integrated process of operating the above-described apparatus. The process for integrating a biomass gasification system with an industrial furnace, comprises feeding a stream of flue gas containing CO₂ and H₂O issued from the industrial furnace into either one or both of a pyrolysis unit and a gasifier unit of the biomass gasification system; and feeding a stream of syngas generated in the biomass gasification system into the industrial furnace as fuel.

### BRIEF DESCRIPTION OF THE FIGURES

Other characteristics and advantages of the invention will become apparent from the following description, which is given by way of example and without implying any limitation, with reference to the appended drawings in which:

FIG. 1 is a schematic diagram of a burner of an industrial furnace.

FIG. 2 is a schematic diagram of an integrated apparatus of an industrial furnace with a biomass gasification system.

### DETAILED DESCRIPTION OF THE INVENTION

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used in another embodiment to yield as still further embodiment.

Gasification is a process that converts organic or fossil fuel based carbonaceous materials into carbon monoxide, hydrogen and carbon dioxide. This is achieved by reacting the material at high temperatures (>700° C.), without combustion, with a controlled amount of oxygen and/or steam. The resulting gas mixture is called syngas (from synthesis gas or synthetic gas) or producer gas and is itself a fuel. In essence, a limited amount of oxygen or air is introduced into the reactor to allow some of the organic material to be “burned” to produce carbon dioxide and energy, which drives a second reaction that converts further organic material to hydrogen and additional carbon dioxide. Further reactions occur when the formed carbon monoxide and residual water from the organic material react to form methane and excess carbon dioxide (4CO+2H₂O→CH₄+3CO₂). This third reaction occurs more abundantly in reactors that increase the residence time of the reactive gases and organic materials, as well as heat and pressure. Catalysts are used in more sophisticated reactors to improve reaction rates, thus moving the system closer to the reaction equilibrium for a fixed residence time.

Several types of gasifiers are currently available for commercial use: counter-current fixed bed (“up draft”), fluidized bed, entrained flow, co-current fixed bed (“down draft”), etc.

Counter-current fixed bed is a fixed bed of carbonaceous fuel (e.g. coal or biomass) through which the gasification agent (steam, oxygen and/or air) flows in counter-current configuration. The ash is either removed in the dry condition or as a slag.

In a fluidized bed gasifier, the fuel is fluidized in oxygen and steam or air. The ash is removed dry or as heavy agglomerates that defluidize. The temperatures are relatively low in dry ash gasifiers, so the fuel must be highly reactive; low-grade coals are particularly suitable.

In an entrained flow gasifier, a dry pulverized solid, an atomized liquid fuel or a fuel slurry is gasified with oxygen (much less frequent: air). The gasification reactions take place in a dense cloud of very fine particles. Most coals are suitable for this type of gasifier because of the high operating temperatures and because the coal particles are well separated from one another.

Co-current fixed bed (“down draft”) gasifier through which the gasification agent gas flows in co-current configuration with the fuel (downwards, hence the name “down draft gasifier”). Heat needs to be added to the upper part of the bed, either by combusting small amounts of the fuel or from external heat sources. The produced gas leaves the gasifier at a high temperature, and most of this heat is often transferred to the gasification agent added in the top of the bed, resulting in energy efficiency on level with the counter-current type.

Suitable biomass gasifier in this invention may be fixed-bed, fluidized-bed or entrained flow type. Examples of such biomass gasifier may be those disclosed in U.S. Pat. No. 8,100,991B2 or CN 100595128C, which are both incorporated by reference herein.

Biomass gasification is an environmentally friendly method of valorizing a renewable energy source. Waste gasification, whereby said waste may be in the form of biomass, for example, corn stalks, wood chips and etc. is an environmentally friendly manner of valorizing and disposing of waste products. However, gasification also requires a significant amount of thermal energy, whereby the required level of thermal energy depends on the gasification process used.

There are a large number of different feedstock types for use in a biomass gasification process, each with different characteristics, including size, shape, bulk density, moisture content, energy content, chemical composition, ash fusion characteristics, and homogeneity of all these properties. A variety of biomass and waste-derived feedstock can be gasified, with wood pellets and chips, waste wood, plastics and aluminum, agricultural and industrial wastes, discarded seed corn, corn stover and other crop residues all being used.

The power derived from gasification and combustion of the resultant gas is considered to be a source of renewable energy if the gasified compounds were obtained from biomass. Making H₂ and CO (syngas) from biomass is widely recognized as a necessary step in the production of various second generation biofuels. There are two major ways to produce a biosyngas: fluidized bed gasification with catalytic reformer or entrained flow gasification. The latter option requires extensive pre-treatment such as flash pyrolysis, slow pyrolysis, torrefaction, or fluidized bed gasification at a low temperature. Cleaned and conditioned biosyngas can be used to synthesize second generation biofuels such as Fischer-Tropsch fuels, methanol, DME, mixed alcohols, and even pure hydrogen. Nevertheless, one disadvantage of biomass gasification is that hydrogen concentration in the resultant syngas is low and thus the resultant syngas is not sufficient as synthesis gas for synthesizing methanol or GTL (gas to liquid fuel). Thus, one objective of the present invention is to efficiently utilize the resultant syngas containing hydrogen and carbon monoxide.

The direct gasification of a heterogeneous solid waste or mixture involves process-operating difficulties due both to product heterogeneity and process instability. Two-stage pyro-gasification, integrated or independent: pyrolysis and gasification, is a stable process using a homogenous product in the second stage of the reaction—the pyrolysis char—a carbon and inert base product.

In this invention, the biomass gasification process is a two-stage gasification process, and the biomass gasification system includes a pyrolysis unit and a gasifier unit. Pyrolysis is the thermal decomposition of the volatile components of an organic substance, in the temperature range of 400-1,400° F. (200-760° C.), and in the absence of air or oxygen, forming syngas and/or liquids. An indirect source of heat is used. A mixture of un-reacted carbon char (the non-volatile components) and ash remains as a residual. Gasification is the next step, which occurs in a higher temperature range of 900-3,000° F. (480-1,650° C.) with very little air or oxygen. In addition to the thermal decomposition of the volatile components of the substance, the non-volatile carbon char that would remain from pyrolysis is converted to additional syngas. Gasification agent (including steam, carbon dioxide or their mixture) may also be added to the gasifier to convert the carbon to syngas. Gasification uses only a fraction of the oxygen that would be needed to burn the material. Heat is supplied directly by the exothermic reaction of partial oxidation of the carbon in the feedstock. Ash remains as a residual.

The following describes a representative example of the biomass gasification apparatus. A biomass gasification apparatus includes a pyrolysis unit and a gasifier unit. The pyrolysis unit comprises a reaction chamber and a hollow chamber which encloses the reaction chamber, the reaction chamber is slightly inclined from a loading port to an extraction port. The reaction chamber is sealed from the external environment to provide a non-oxidizing environment. A thermal medium, which is supplied to the internal region of the hollow chamber, serves as a heat source for the reaction chamber. The biomass material held in a raw material hopper is supplied by a feeder into the reaction chamber of the pyrolysis unit, after which it is dried and thermally cracked by the indirect application of thermal energy to generate a tar-containing pyrolysis gas and char which exit through the extraction port. The extraction port of pyrolysis unit connects to the gasifier, the tar containing pyrolysis gas and char move from the pyrolysis unit to the gasifier through an insertion port, gasification agent is supplied to gasifier and react with pyrolysis gas to generate fuel gas. After the tar component contained in the pyrolysis gas has been thermally cracked, the pyrolysis gas is drawn toward a gas extraction port in the gasifier by a suction fan during which the char is subjected to a gas-solid reaction such as a carbon oxidation reaction (C+CO₂→2CO) or hydro-gasification reaction (C+H₂O→CO+H₂). The suction fan sucks the combustible resultant syngas (including carbon monoxide or hydrogen) through a filter for particle removal, and sends the resultant syngas to the burner.

An industrial furnace is an equipment used to provide heat for a process or can serve as reactor which provides heat for a reaction. Furnace designs vary as to its function, heating duty, type of fuel and method of introducing combustion air. Fuel flows into the burner and is burnt with air provided from an air blower.

Combustion process in the furnaces produces flue gas containing high concentrations of CO₂ and H₂O with very high temperature. After the flue gas leaves the furnace, most furnace designs include a convection section where more heat is recovered before venting to the atmosphere through the flue gas stack.

The said industrial furnace, especially glass furnace or melting furnace for non-ferrous metals are particularly suitable for this invention. Because high temperature combustion process in above mentioned industrial furnace could produce flue gas at a temperature higher than 1000° C., in the case of glass furnaces, the generated flue gas is at a temperature of about 1400° C.

Conventional glass melting furnaces use burners to melt glass forming materials such as sand, soda ash, limestone, dolomite, feldspar, rough and others, collectively referred to as batch. The glass forming materials may also comprise broken glass, such as scrap glass being recycled, or cullet. Because of the high temperatures required to melt glass forming materials, glass melting furnaces operate at temperatures that are among the highest of all industrial furnaces. Hot combustion products are generated in these furnaces; potentially, large amounts of heat can be lost as the combustion products proceed up the flue of the furnace. It is known to recover energy from hot flue gases generated in glass furnaces to preheat the combustion air.

Solid fuel refers to various types of solid material that are used as fuel to produce energy and provide heating, usually released through combustion. Solid fuels include wood (see wood fuel), charcoal, peat, coal, Hexamine fuel tablets, and pellets made from wood (see wood pellets), corn, wheat, rye and other grains. For economic reasons, high heating-value solid fuels are often the fuel of choice in industrial combustion processes. Examples of such solid fuels feedstock of industrial furnace are petcoke (also known as petroleum coke) and coal. The solid fuels are generally used in the form of small particulate form and are transported towards the combustion zone by means of a conveyor gas, usually air. Disadvantages of the use of such solid fuels are difficult ignition (compared to liquid or gaseous fuels) and, in many cases, the presence of sulfur-containing compounds in the flue gas and the short lifetime of furnace. And the use of some solid fossil fuels (e.g. coal) is restricted or prohibited in some urban areas, due to unsafe levels of CO₂ emissions, unsustainability of fossil fuels and high cost.

TABLE 1
Comparison of Properties of Solid Fuels
Properties of petcoke, weight oil, coal, wood

| | | | | Fixed | | | | | | LHV, |
|---|---|---|---|---|---|---|---|---|---|---|
| | M, | Ash, | Vm, | Carbon, | C, | H, | O, | N, | S, | MJ/kg, |
| | ad % | ad % | ad % | ad % | ad % | ad % | ad % | ad % | ad % | ad |
| Petcoke | 0.51 | 0.18 | 12.15 | 87.1 | 87.9 | 3.87 | 1.09 | 1.99 | 4.47 | 35.72 |
| Weight oil | 0.01 | 0.001 | 99.52 | 0.46 | 86.7 | 12.9 | 0 | 0.03 | 0.08 | 42.7 |
| Coal | 4.18 | 11.83 | 31.56 | 52.43 | 68.36 | 3.85 | 9.28 | 2.38 | 0.11 | 27.14 |
| Wood | 8.24 | 0.5 | 83.53 | 7.73 | 47.31 | 5.6 | 35.89 | 2.43 | 0.017 | 17.77 |

* ad—air dry base; M—moisture, Vm—Volatile matter; C—Carbon; H—Hydrogen; O—Oxygen; N—Nitrogen; S—Sulfur; LHV—Low level heat value

Table 1 compares the properties of 4 types of solid fuels. Among them, Petcoke is a challenging fuel due to its low volatile content, high sulfur and nitrogen content, which give rise to undesirable emission characteristics. However, the low price and increased production of petcoke from high-sulfur feedstock give a powerful economic stimulus to use it for supplying heat. It has been widely applied in commercial furnaces, especially in China, such as glass furnaces.

Petcoke is over 90 percent carbon and emits 5 to 10 percent more carbon dioxide (CO₂) than coal on a per-unit-of-energy basis when it is burned. An oxygen enrichment process is often applied for petcoke utilization, especially in an industrial glass furnace, which allows efficient combustion of petcoke. Enrichment of combustion air with stream or streams of relatively high purity oxygen enhances the combustion process by increasing the rate of diffusion between fuel and oxidizer (via higher oxygen concentration) and increasing combustion temperature. Therefore, particle heat up is much more rapid and combustion is inherently more stable.

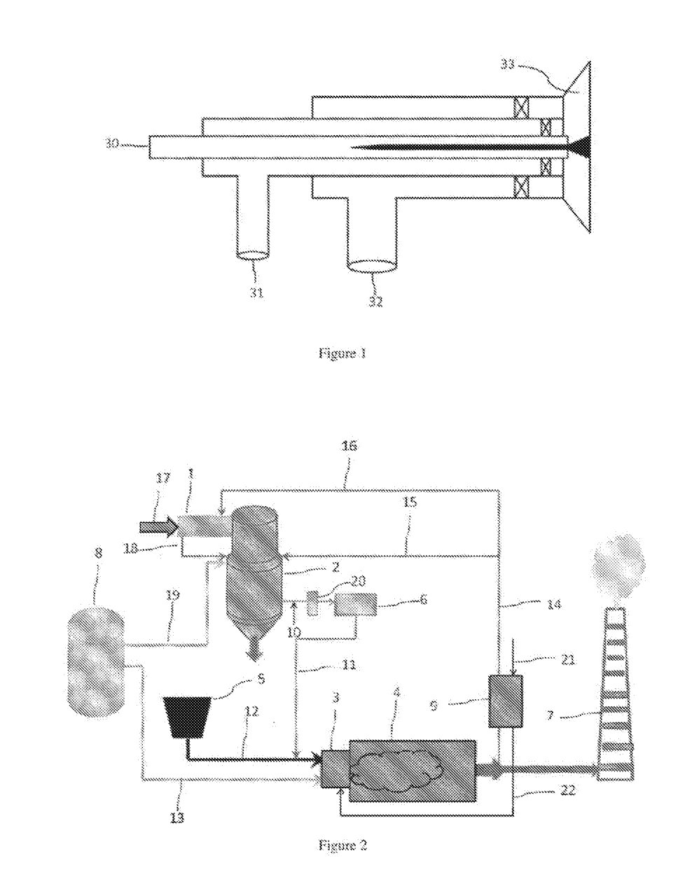

The industrial furnace includes a burner, which is in fluid communication with a source of oxygen or oxygen-enriched air via an oxygen/air nozzle. A typical burner comprises a fuel nozzle in fluid communication with fuel feeding pipe and a supplementary nozzle in fluid communication with a support fuel feeding conduit. The outlet of burner faces the combustion chamber of furnace. A typical burner suitable for oxygen-enriched combustion is illustrated in FIG. 1, including a solid fuel inlet 30, a syngas inlet 31, an oxygen-enriched air/oxygen inlet 32 and a burner outlet 33.

This invention combines a high temperature solid-fuel combustion process in an industrial furnace with biomass gasification process, whereby the high temperature flue gas issued from the solid-fuel combustion process is introduced into the biomass gasification system to improve the efficiency of the gasification process and the syngas generated by the biomass gasification process is introduced into the industrial furnace to improve the combustion of the solid fuel.

High temperature combustion processes in the industrial furnace, such as glass melting and non-ferrous metals melting furnaces capable of producing flue gas at temperature higher then 1000° C., generate a flow of high-temperature flue gas (in the case of glass-melting furnaces at a temperature of about 1400° C.). Generally, the flue gas comprises CO₂ (vol. %>12%, typically >40%), H₂O (vol. %>18%, typically >28%), with temperature>1300° C. The biomass gasification process produces syngas, it is combustible and often used as a fuel, which consisting primarily of hydrogen, carbon monoxide, and very often some carbon dioxide.

In this invention, blending syngas generated through gasification of biomass with solid fossil fuel could reduce the consumption of fossil fuels such as petcoke and stabilize and complete combustion of petcoke in the furnace. This way, the volume of petcoke needed for a certain combustion process may be decreased, which leads to reduced SOx concentration in the furnace, thereby elongating the life time of the furnace. In accordance with the invention, at least part of said hot flue gas generated from the industrial furnace is supplied to the gasification process, thus providing heat, CO₂ and H₂O to the gasification process. By using waste heat from the high-temperature solid-fuel combustion process as a heat source for the gasification process, the energy efficiency of the gasification process and combustion process are significantly improved together.

The suitable biomass gasifier comprises separate pyrolysis unit and gasifier unit. Part of the flue gas generated from the industrial furnace is introduced into the pyrolysis unit and provides indirect heat to the solid biomass to convert it into tar-containing pyrolysis gas and char. The tar-containing pyrolysis gas and char then enter the gasifier unit and get mixed with another part of hot flue gas transported from the industrial furnace. Under high temperature, the major components of flue gas—CO₂ and H₂O react as gasification agent with oxygen and pyrolysis gas and char to produce syngas. The main reactions involving flue gas are as the following:

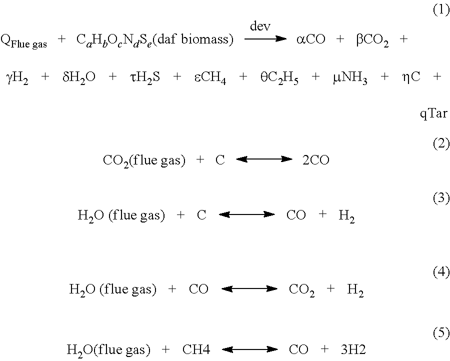

The way in which the integrated apparatus operates is explained below by setting out in detail.

FIG. 2 is a block diagram illustrates the present disclosure. An integrated apparatus comprises a biomass gasification system containing a pyrolysis unit 1, a co-current fixed bed gasifier unit 2 and an industrial glass furnace 4 with a burner 3. A conduit 14 feeds a stream of flue gas produced from the industrial glass furnace into a heat-exchanger 9, the flue gas comprises CO₂ and H₂O and is at a temperature of about 1450° C. After passing through the heat-exchanger 9, the temperature of flue gas goes down from 1400-1500° C. to 400° C. before entering the biomass gasification system. A conduit 10 feeds a stream of syngas generated in the biomass gasification system into a purification system 20 and then a booster 6, the pressure of syngas in conduit 11 is raised to about 3 bars by the pressure booster before being introduced into the glass furnace 4, which ensures ready ignition as well as stable and complete combustion of petcoke in the furnace. Syngas can be blended into the burner through syngas inlet 31 (FIG. 1) with petcoke transferred from petcoke hopper 5 through conduit 12 which connected the solid fuel inlet 30 (FIG. 1) of burner 3. A steam of oxygen is introduced from LOX tank 8 through conduit 13 which connects with oxygen inlet 32 (FIG. 1) of the burner. CO and H₂ in the syngas can help the ignition and combustion of petcoke. The burner outlet 33 (FIG. 1) faces the combustion chamber of glass furnace 4. Pre-heated air could be used as oxidant of combustion process in the burner too, air is introduced into the burner 3 of glass burner by passing through the heat-exchanger 9 from an air inlet 21, the temperature of air in conduit 22 is about 1100° C.

Instead of the conventional method, where all the flue gas is transported to a stack 7 to utilize the waste heat, here part of the flue gas is introduced into the gasification system to facilitate pyrolysis of solid biomass and as reactant in the gasification process, through conduit 14, wherein, part of flue gas is introduced to a pyrolysis unit 1 through conduit, the tar-containing pyrolysis gas and char generated from the pyrolysis unit then enter the gasifier unit 2 and get mixed with another part of hot flue gas transported through conduit 15 as well as cooled flue gas passed through the pyrolysis unit through conduit 18. A stream of oxygen is input into the gasifier unit 2 as gasification agent from LOX tank 8 through conduit 19.

To maintain the temperature of hot flue gas, ideally, the biomass gasification system and the industrial glass furnace shall be in close vicinity and the hot flue gas is transported in air-tight pipes built by thermal materials such as thermal bricks. Suction fans can be connected to the gasifier to draw flue gas into the units.

Thus the energy efficiency of both the gasification process and the high-temperature combustion process are improved, and the carbon footprints of both are reduced.

A set of designed operation parameters of biomass co-current fixed bed gasifier is shown in table 2. In one example, an ambient pressure co-current fixed bed gasifier converts 1350 kg/hr agriculture waste into 1479 Nm³/hr syngas which comprises 36.01 Vol. % of CO, 29.18 Vol. % of H₂ and low tar (20-60 ppm), at a temperature of 40° C. The heating value (HV) of syngas is 1884.5 Kcal/Nm³ and its pressure is ambient pressure. After a syngas booster, the syngas pressure is promoted to 3 bars. Then Syngas and 2220 kg/hr petcoke are introduced into oxy-petcoke burner and burnt with pure oxygen introduced from LOX tank. It can produce 25 MW heat for the glass furnace. Part of the flue gas (330-350 Nm³/hr, 5.26 vol. % of total flue gas, the flue gas flow ratio between conduit 16 and conduit 15 is 2:1) are recycled into gasification system with 270 Nm³/hr pure oxygen as gasification agent, the oxygen concentration of gasification is about 45%. Comparing with existing oxy-petcoke combustion process, this new process can reduce 10% carbon emission. It also can reduce NO_{X} emission by replacing air with syngas for petcoke conveying. At the same time, the new process can save 12% of petcoke and treat 10 kt/hr agriculture waste.

Table 3 illustrates calculations for three types of combustion systems in the glass furnace, which takes 300 ton/d glass product line to theoretically calculate the fuel consumption and flue gas emission based on heat and mass balance. Case01: biomass syngas-petcoke-oxygen combustion furnace; Case02: petcoke-oxygen combustion furnace; Case03: petcoke-air combustion furnace. According to table 3, it shows that under the same product scale, Case01 has the lowest petcoke consumption, CO₂ emission, NO_{X} emission and SO_{X} emission. Petcoke consumption is 7.92 ton less than Case02 and Case03 per day. CO₂ emission in flue gas is generated from two sources, one from petcoke combustion, another from biomass gasification, CO₂ emission from petcoke combustion of Case01 is less than Case02 and Case03 by approx. 24 ton/d, and CO₂ emission from biomass gasification process is not counted into net CO₂ emission, so Case01 has lower net CO₂ emission than Case02 and Case03. The heat in flue gas for Case01 is also the lowest, over 4 times lower than Case03, which means that the heat efficiency of Case01 is the highest; 5.26% hot flue gas can also be recycled into biomass gasification system in Case01.

While the invention has been described in detail with reference to the preferred embodiments thereof, it will be apparent to one skilled in the art that various changes and modifications can be made and equivalents employed, without departing from the present invention.

TABLE 2
Designed Operation Parameters of biomass Gasifier

| | | |
|---|---|---|
| Items | Unit | Parameter |

| | | | |
|---|---|---|---|
| Feeding | Biomass | Kg/hr | 1200~1500 |
| | Oxygen | Nm³/hr | 150~250 |

| | | |
|---|---|---|
| Oxygen concentration | % | 21~100 |
| Operation pressure | / | ambient |
| Pressure drop | Pa | ≤2500 |

| | | | |
|---|---|---|---|
| Operation | Pyrolysis | ° C. | 350~500 |
| Temperature | screw | | |
| | Combustion | ° C. | 1000~1200 |
| | zone | | |
| | Gasification | ° C. | 600~1000 |
| | zone | | |
| Output | Syngas flow | Nm³/hr | 1500~2000 |
| | Slagging | Kg/hr | 150~200 |

TABLE 3
Comparison of Three Combustion Systems
300 ton/d glass Product Line

| | | | | Case02: | Case03: |
|---|---|---|---|---|---|
| | | Case01: Biomass | | Oxygen- | Air- |
| | | syngas-petcoke | | petcoke | petcoke |
| | Items | system | | system | system |
| Feed- | Petcoke | 2.22 | | 2.55 | 2.55 |
| stock | consumption, | | | | |
| | ton/hr | | | | |
| | Biomass | 1.35 | | / | / |
| | consumption, | | | | |
| | ton/hr | | | | |
| | Syngas, NM³/hr | 1479 | | / | / |
| | Oxygen | Gasification | 0.39 | 6.53 | / |
| | consumption, | Combustion | 7.01 | | |
| | ton/hr | | | | |

| | | | | |
|---|---|---|---|---|
| | Air consumption, | / | 1.73 | 31.51 |
| | ton/hr | | | |
| Flue gas | CO₂ from | 7.21 | 8.28 | 8.28 |
| emis- | petcoke, ton/hr | | | |
| sion | CO₂ from | 1.88 | 0.00 | 0.00 |
| | biomass, ton/hr | | | |
| | H₂O, ton/hr | 1.13 | 0.90 | 0.9 |
| | Hot N₂, ton/hr | 0.13 | 1.36 | 23.82 |
| | SO₂, ton/hr | 0.20 | 0.23 | 0.23 |
| | NOx, ton/hr | Low | Medium | High |
| | Heat in flue gas, | 11,919.46 | 12,668.56 | 44,755.70 |
| | MJ/hr | | | |
| | (T_{fuelgas} = | | | |
| | 1200° C.) | | | |
| | Recycled flue gas | 5.26% | / | / |
| | percentage, | | | |
| | vol % | | | |

Note:
heat consumption of glass melting: 6500 kJ/kg, Annealing heat: 700 kJ/kg, Flue gas temperature 1200° C., without considering the heat loss of glass furnace.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by hose skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-14. (canceled)

15. An integrated apparatus comprises a biomass gasification system containing a pyrolysis unit and a gasifier unit, an industrial furnace, a conduit feeding a stream of flue gas containing CO₂ and H₂O issued from the industrial furnace into the biomass gasification system, a conduit feeding a stream of syngas generated in the biomass gasification system into the industrial furnace, a conduit feeding a stream of oxygen or oxygen-enriched air as gasification agent to the gasifier unit, wherein the stream of flue gas is introduced into either one or both of the pyrolysis unit and the gasifier unit of the biomass gasification system.

16. The integrated apparatus of claim 15, wherein the stream of flue gas enters into the gasifier unit after passing through the pyrolysis unit of the biomass gasification system.

17. The integrated apparatus of claim 15, wherein the gasifier unit is selected from a fixed-bed gasifier, an entrained flow gasifier or a fluidized gasifier.

18. The integrated apparatus of claim 17, wherein the stream of syngas generated in the biomass gasification system is at a pressure of equal or greater than 2 bars before being introduced into the industrial furnace.

19. The integrated apparatus of claim 15, wherein the industrial furnace is selected from glass furnace or melting furnace for non-ferrous metals.

20. The integrated apparatus of claim 19, wherein a feedstock of the industrial furnace comprises petcoke.

21. The integrated apparatus of claim 20, wherein air, oxygen-enriched air or oxygen is used as the combustion oxidant in the industrial furnace.

22. A integrated process including a biomass gasification system and an industrial furnace, comprising the steps of:
feeding a stream of flue gas containing CO2 and H2O issued from the industrial furnace into either one or both of a pyrolysis unit and a gasifier unit of a biomass gasification system;
feeding a stream of syngas generated in the biomass gasification system into the industrial furnace as fuel; and
feeding a steam of oxygen or oxygen-enriched air into the gasifier unit as gasification agent.

23. The process of claim 22, wherein the stream of flue gas enters into the gasifier unit after passing through the pyrolysis unit of the biomass gasification system.

24. The process of claim 22, wherein the gasifier unit is selected from a fixed-bed gasifier, an entrained flow gasifier, or a fluidized gasifier.

25. The process of claim 22, wherein the stream of syngas generated in the biomass gasification system is at a pressure equal or greater than 2 bar before being introduced into the industrial furnace.

26. The process of claim 22, wherein the industrial furnace is selected from a glass furnace or a melting furnace for non-ferrous metals.

27. The process of claim 26, wherein a feedstock of the industrial furnace comprises petcoke.

28. The process of claim 27, wherein air, oxygen-enriched air or oxygen is used as the combustion oxidant in the industrial furnace.
